(19) United States
(12) Patent Application Publication
(10) Pub. No.: US 2026/0048374 A1
(43) Pub. Date: Feb. 19, 2026

(54) Device for the Detection of Incipient Sheeting in a Gas Phase Reactor

(71) Applicant: ExxonMobil Chemical Patents Inc., Spring, TX (US)

(72) Inventor: Michael G. TRIBO, Humble, TX (US)

(21) Appl. No.: 19/102,924

(22) PCT Filed: Aug. 7, 2023
(86) PCT No.: PCT/US2023/071764

§ 371 Date: Feb. 11, 2025

Related U.S. Application Data
(60) Provisional application No. 63/373,109, filed on Aug. 22, 2022.

(51) Int. Cl. B01J 8/08; C08F 10/00

(52) U.S. Cl. CPC B01J 8/082; B01J 8/085; C08F 10/00; B01J 2208/00539; B01J 2208/00548; B01J 2208/00707; B01J 2208/00752; B01J 2208/00938; C08F 2400/02

(57) ABSTRACT

Methods for detecting incipient sheeting in a polyolefin gas phase reactor. The method can include flowing one or more monomer gases through a first tubular protruding through a reactor wall, flowing one or more monomer gases through a second tubular protruding through the reactor wall, wherein the first tubular is located within the second tubular, and measuring a pressure differential of the monomer gases flowing through the first and second tubulars. Based on the measured pressure differential, incipient sheeting within the reactor can be detected and one or more redial measures can be employed to control or reverse the sheeting.

### REFERENCE TO CROSS-RELATED APPLICATION

This application claims the benefit of U.S. Provisional Application 63/373,109 filed Aug. 22, 2022, entitled “Device for the Detection of Incipient Sheeting in a Gas Phase Reactor”, the entirety of which is incorporated by reference herein.

### FIELD

Embodiments of the present invention generally relate to gas phase polymerization. More particularly, embodiments of the present invention relate to devices for detecting incipient sheeting in a polyolefin gas phase reactor.

### BACKGROUND

Sheeting in a gas phase reactor can cause a reactor to be shut down if the sheets grow large enough. Existing methods of sheet detection have used temperature monitoring and/or nuclear instrumentation at the plate level to detect the presence of a sheet, polymer chunks, or other large cluster of solid polymer. These known methods, however, cannot detect trouble until the cluster of solid polymer has grown too large to mitigate and prevent a shutdown.

There is a need, therefore, for new devices and methods for polymer agglomeration detection within a gas phase reactor.

Some references of potential interest in this regard include: U.S. Pat. Nos. 3,779,712; 4,532,311; 7,985,811; and 7,634,937; as well as EP0366823, EP1082351, EP1082350, EP1106984, EP2101908, and EP0233787.

### SUMMARY

Methods and devices for olefin polymerization within a gas phase reactor as well as detecting incipient sheeting in a gas phase reactor are provided herein. A method for retrofitting a gas phase polymerization reactor using slurry injection is further provided.

In one embodiment, the method for detecting incipient sheeting can include flowing one or more fluids through a first tubular protruding through a reactor wall and measuring a pressure differential of the fluids flowing through the first tubular across a first point and a second point along the tubular or upstream of the tubular (with respect to fluid flow direction). The tubular preferably protrudes through the reactor wall in a substantially horizontal orientation (e.g., substantially perpendicular to the reactor wall), and has an inner diameter of less than or equal to 1 inch (2.54 cm), such as less than or equal to 0.5 inches, and is disposed along the wall at an elevation above a distribution plate within the reactor. Based on the measured pressure differential, incipient sheeting within the reactor can be detected and one or more remedial measures can be employed to control or reverse the sheeting to avoid shutdown. Optionally, the first tubular can be disposed within a second tubular having greater inner diameter than the outer diameter of the first tubular, and the two tubulars are substantially concentric when viewed in a head-on cross-section, such that an annulus is defined between the first and second tubulars.

In another embodiment, the method for olefin polymerization within a gas phase reactor can include injecting a catalyst mixture into the gas phase reactor through one or more catalyst injectors that each protrude substantially horizontally through a wall of the reactor at a first elevation within the reactor above a distributor plate within the reactor, wherein each catalyst injector comprises a first tubular disposed within a second, larger tubular, forming an annulus therebetween, and further wherein the catalyst mixture (comprising catalyst particles and carrier fluid) flows through the first tubular of the catalyst injector and an additional fluid (e.g., monomer gas, ICA, and/or purge gas) flows through the second, larger tubular of the catalyst injector. The carrier fluid can comprise a solvent such as mineral oil, hexane, or another hydrocarbon liquid (e.g., for a slurry catalyst mixture), and/or carrier gas such as inert condensing agent (ICA), purge gas, or other hydrocarbon or inert gas; the additional fluid can be the same as the fluid flowing through the first tubular, or different (and comprise one or more of ICA, purge gas, monomer gas, or other hydrocarbon or inert gas), noting that the carrier fluid should be inert, while the additional fluid is preferably inert, but need not necessarily be inert. Further, one or more monomer gases can be provided to the reactor (optionally, the one or more monomer gases can be injected through at least one monomer injector protruding through the wall of the reactor at either the same elevation as the first elevation or at a second elevation different from the first elevation within the reactor). The one or more monomer gases can be polymerized in the presence of the catalyst within the reactor to form finely divided solid polymer particles; and a pressure differential and/or flow rate in the first and/or second tubular of each of the one or more catalyst injectors can be measured (e.g., the measurement may be taken along or upstream of the tubular). Also or instead, pressure differential and/or flow rate in a monomer injector (if employed) can be measured (similarly along or upstream of the monomer injector). A substantial decrease in the pressure differential at any of the aforementioned tubular and/or injectors indicates the presence of incipient sheeting within the reactor. Therefore, based at least in part upon a detected decrease in the measured pressure differential and/or flow rate value, one or more remedial measures can be employed to control or reverse the sheeting to avoid shutdown.

In another embodiment, the method for retrofitting a gas phase polymerization reactor using slurry injection can include adding one or more devices for injecting one or more fluids into the reactor, where each device has at least one flow path therethrough and one or more instruments for measuring bursts of pressure change through the flow path. The one or more devices are located below catalyst injection nozzles for slurry injection and above a distribution plate within the reactor. A hydrocarbon liquid or gas can flow through each of the one or more added devices, and intermittent pressure drops can be detected through each device to detect for sheet formation within the reactor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1 depicts an illustrative device for detecting incipient sheeting inside a polymer reactor, according to one or more embodiments described herein.

FIG. 2 depicts a schematic of an illustrative gas phase polymerization reactor.

FIG. 3 depicts an illustrative partial section view of the reactor through lines 3-3 of FIG. 2.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the formation of a first feature over or on a second feature in the description that follows can include embodiments in which the first and second features are formed in direct contact and can also include embodiments in which additional features can be formed interposing the first and second features, such that the first and second features are not in direct contact. Finally, the embodiments presented below can be combined in any combination of ways, i.e., any element from one embodiment can be used in any other embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 wt %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

The term “α-olefin” refers to any linear or branched compound of carbon and hydrogen having at least one double bond between the α and β carbon atoms. For purposes of this specification and the claims appended thereto, when a polymer or copolymer is referred to as including an α-olefin, e.g., poly-α-olefin, the α-olefin present in such polymer or copolymer is the polymerized form of the α-olefin.

The term “in fluid communication” signifies that fluid can pass from a first component to a second component, either directly or via at least a third component. The term “inlet” refers to the point at which fluid enters a component, and the term “outlet” signifies the point at which fluid exits a component.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

Various embodiments of this disclosure include methods for detecting incipient sheeting in a gas phase polymerization reactor, such as a fluidized bed polymerization reactor in which a fluidized bed is established by channeling gases through a distribution plate disposed at a bottom portion of the reactor, such that the gases flow upward through a mass of particles typically comprising catalyst and growing polymer granules. The gas flow and distribution are in accordance with well-known principles for establishing and maintaining the fluidized bed of particles within the reactor. However, as noted previously, these particles can, under conditions within the reactor, agglomerate into larger and larger chunks or “sheets”—phenomenon known as “sheeting.” The present methods include delivering one or more fluids (e.g., monomer gas, catalyst particles in carrier gas and/or solution, or a combination thereof) to the reactor via a tubular protruding substantially horizontally through a wall of the reactor and into the interior of the reactor, preferably at an elevation along the reactor wall such that the tubular extends into the fluidized bed zone within the reactor. A pressure drop and/or flow rate of the fluid is continuously measured across a portion of the tubular (e.g., a pressure drop between a first point and a second point along the tubular), and incipient sheeting is detected based upon the measured pressure drop (or flow rate). In particular, it is believed that any polymer agglomerates beginning to form in the fluidized bed zone will move rapidly around the zone, and soon after formation will strike or otherwise contact the tubular such that flow is interrupted.

Advantageously, if the tubular diameter is sufficiently small, a quick strike and/or small agglomerate will substantially interrupt flow of the fluid through the tubular, causing a relatively large drop in the measured pressure drop (or flow rate) value, such that when such a drop is detected, the presence of incipient sheeting can readily be inferred. Thus, the present method provides an advantageous early warning of sheeting, enabling corrective measures to be taken to mitigate or reverse the sheeting problem, thereby avoiding reactor shutdown.

By employing a tubular with sufficiently small inner diameter (e.g., 1 inch (2.54 cm) or less, preferably 0.5 inches (1.27 cm) or less, most preferably 0.25 inches (0.635 cm) or less, such as within the range from 0.1 to 0.25, 0.5, 0.75, or 1.0 inches) and that penetrates the reactor in a substantially horizontal orientation (that is, perpendicular to the reactor wall and parallel to the distribution plate), the present methods offer significant advantages over other previously disclosed methods of detecting sheeting that rely upon vertical conduits, switches, or other means disposed through the distribution plate, where a sizeable amount of sheeting would be required before initial detection at or near the distribution plate. See, e.g., EP2101908 and EP0233787. The advantages of the present method can be further enhanced through certain particular configurations; for instance, a device comprising two tubulars (an inner tubular and outer tubular in concentric orientation such that the inner tubular is disposed within the outer tubular, forming an annulus therebetween) can be used. The inner tubular furthermore can be flexible, while the outer, or support, tubular is rigid; and the inner tubular can protrude into the reactor an additional fraction (e.g., between 1/32 inch and 5 inches) farther than the outer tubular, such that the flexible end-point of the inner tubular can be struck by initially forming agglomerates in a manner that significantly inhibits flow out of the tubular, thereby enabling detection of a substantial decrease in measured pressure drop (or flow rate) through the inner tubular.

Furthermore, the present methods advantageously can be employed using existing devices, such as catalyst feeders or other tubulars used for delivering gas into a reactor via substantially horizontal tubulars penetrating the reactor wall; also or instead, however, the methods could be employed using a dedicated tubular (or device comprising inner and outer tubulars) positioned along and horizontally penetrating the reactor wall a short distance above (or nearly adjacent to) a distribution plate, so as to detect sheeting at the plate level as early as possible.

Although, as noted, the methods can be employed using a single tubular protruding horizontally into the reactor, certain embodiments employ a configuration with inner and outer tubulars as just mentioned. Such configurations are discussed in more detail below, as are the gas phase polymerization reactor and process, in connection with the Figures.

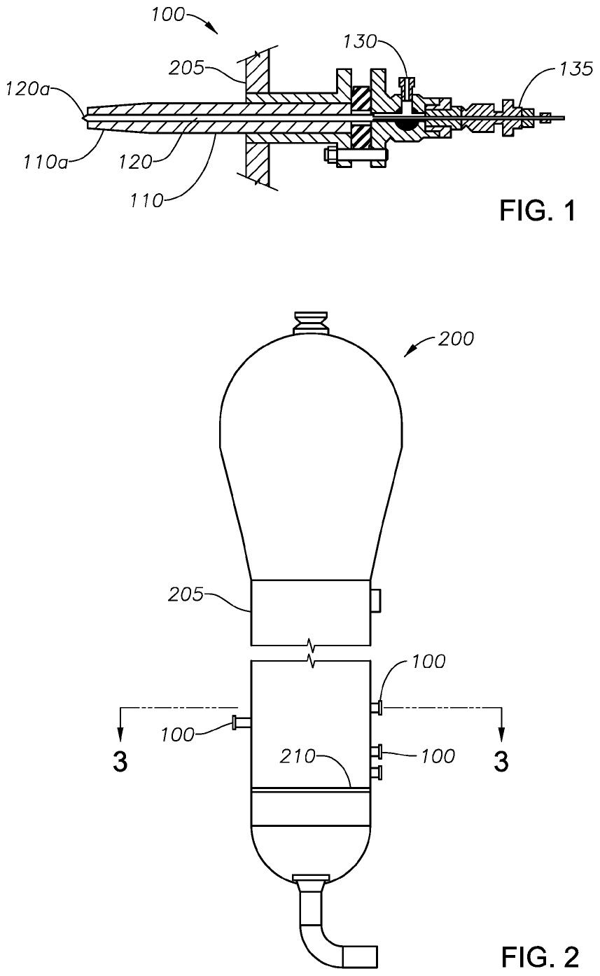

FIG. 1 depicts an illustrative device 100 for detecting incipient sheeting inside a gas phase polymerization reactor, according to one or more embodiments. The device 100 can include an injection tubular or first tubular 120 disposed within a support tubular or second tubular 110; the injection tubular 120 and support tubular 110 are preferably concentric; the injection tubular 120 has a smaller outer diameter (O.D.) than the inner diameter (I.D.) of the surrounding support tubular 110, forming an annulus therebetween. The first and second tubulars are preferably oriented substantially horizontally (e.g., substantially perpendicularly to the reactor wall) and protrude into the reactor 200 above a distribution plate 210 located near the bottom of the reactor, as depicted in FIG. 2. The device 100 can be located at any suitable height above the distribution plate 210, and including a height such that the device 100 is nearly abutting the distribution plate (while still extending substantially horizontally into the reactor), such as, for example, at a distance within the range from a low of any one of about 0.2 ft, 0.5 ft, 0.7 ft, 0.9 ft, 1 ft, 2 ft, 3 ft, 4 ft, 5 ft, or 6 ft to a high of any one of about 3, 4, 5, 6, 7, 8, 9, 10, 15, or 20 ft above the distribution plate 210 (with ranges from any foregoing low end to any foregoing high end contemplated, provided the high end is greater than the low end). It will be appreciated that the size of the reactor will impact the elevation above the distribution plate 210 at which the device 100 is disposed; at any rate, the device 100 is preferably disposed at an elevation along the reactor wall 205 such that the device 100 protrudes into the fluidized bed zone of the reactor 200. The support tubular 110 can be fixed to the reactor wall 205 and the injection tubular 120 can be removable from the support tubular 110. The smaller injection tubular 120 can be inserted through a packing gland into the larger, surrounding support tubular 110. The packing gland can be used to provide a fluid tight seal around the injection tubular 120 and between the support tubular 110.

Optionally, as described previously, the inner tubular can optionally be at least partially flexible. On the other hand, the outer or support tubular is preferably substantially rigid. More particularly, the surrounding outer tubular 110 can be sized (and made of a material) suitable to withstand the forces of the fluidized bed and the force of a falling sheet within the reactor 200. The surrounding outer tubular 110 can accordingly serve as a support tubular for the inner injection tubular 120 located therein. The surrounding outer tubular 110 or simply “support tubular” is typically a heavy walled pipe and, as noted above, has an inner diameter that is greater than the outer diameter of the inner tubular 120. The internal diameter of the outer tubular 110 can range from about ¼ inch to about 5 inches (0.64 cm to 12.7 cm), preferably about ½ inch to about 3 inches (1.3 cm to 7.6 cm), and more preferably about ¾ inch to about 2 inches (1.9 cm to 5 cm), with ranges from any foregoing low end to any foregoing high end also contemplated, provided the high end is greater than the low end (e.g., ½ about inch to about 2 inches (about 1.3 cm to about 5 cm). The length of the surrounding outer tubular 110 can range from about 30″ to 50″. The tubular 110 can extend into the reactor 200 or can terminate flush against the inner surface of the reactor wall 205. The end of the tubular 110 can be cut flat and perpendicular to the axis of the tubular 110 or it can be tapered at an angle ranging from about 10 to 80 degrees. The end of the support tubular 110 can also be polished or coated with an anti-static or anti-fouling material.

The smaller diameter or inner tubular 120 can have an inner diameter less than about 1″, or less than about 0.5″, more preferably less than about 0.25″, such as less than 0.20″ or less than 0.1875″, and, in configurations where an outer or support tubular 110 is used, the inner diameter of the inner tubular 120 is of course smaller than its outer diameter, and in turn the outer diameter of the inner tubular 120 is less than the inner diameter of the support tubular 110. The inner or injection tubular 120 can extend into the reactor 200 through a compressed chevron packing and into the fluid bed a distance of about 0.1 inch to 10 feet (0.25 cm to 3.1 m), preferably about 1 inch to 6 ft (2.5 cm to 1.8 m), and more preferably about 2 inches to 5 feet (5 cm to 1.5 m). Typically, the depth of insertion depends on the diameter of the reactor 200 and typically extends about 1/20^{th} to ½ of the reactor diameter, preferably about 1/10^{th} to ½ and more preferably about ⅕^{th} to ⅓^{rd} of the reactor diameter.

The end (e.g. “first end”) 120a of the injection tubular 120 can be flush with the end (e.g. “first end”) 110a of the support tubular 110. The end 120a of the inner tubular 120 can also extend beyond the end 110a of the support tubular 110. For example, the end 120a of the inner tubular 120 can extend about ⅙″, ⅛″, 3/16″, 0.25″, or ½″ from the end 110a of the outer tubular 110, such as within the range from a low of any one of about 1/16, 3/16, ¼, or ½ inches to a high of any one of about ½, ¾, 1, 2, 3, 4, or 5 inches, provided the high end is greater than the low end. Such a configuration may advantageously expose the end of the tubular to sheets swirling within the fluidized bed of the reactor, more readily registering flow interruptions that result in decreased pressure drop (or flow rate) measurements across the inner tube, thereby better signaling incipient sheeting.

The end 120a of the injection tubular 120 can be cut perpendicular to its axis to create a conical end or point with an angle ranging from 0 to 90 degrees, preferably ranging from about 0 to 60 degrees or 10 to 80 degrees. The tubular 120 can be coated with an antifouling or antistatic compound.

Still referring to FIG. 1, the device 100 can further include one or more flow instruments (two are shown 130, 135) or other instrument for measuring, alerting and/or detecting fluctuations in flow and/or pressure through the tubulars 110, 120. For instance, such instrument can be suitable for measuring pressure drop across said instrument (such that the pressure drop is measured from a first point, being the upstream end of the instrument with respect to fluid flow through the tubular, to a second point, being the downstream end of the instrument). More generally, it is convenient to utilize a first point and second point for pressure drop measurements that are reasonably close to each other along the tubular; or that are on either sides of a device such as the instrument just-noted; as long as the distance and/or instrument over which pressure drop is measured is adequately large such that one would obtain a measurable pressure drop across the measured locations. The ordinarily skilled artisan will be well-versed in selecting a means of determining measurable pressure drop along a tubular, although it is noted that distances such as 0.5 ft, 1 ft, 1.5 ft, 2 ft, 5 ft, or more may be suitable, when not employing a specific device for measuring pressure drop. Similarly, pressure drop may be measured across a particular fitting such as a pickup block or other fitting. Most generally, for practice of the methods described herein, any distance for pressure drop measurements will be suitable, as long as the distance is consistent such that changes (e.g., reductions) in the measured pressure drop due to, e.g., sheeting interacting with the tubular's reactor-facing opening can be detected, and as long as the distance is adequately large such that, considering the tubular (including any fitting) across which pressure drop is measured, a measurable pressure drop can be obtained without mistaking changes for noise in the measurement. The pressure drop can be measured across the first and second points along the tubular or upstream of the tubular (e.g., in adjoining piping, flanges, fittings, or the like). When using flow instruments 130, 135 for such purposes, the instruments 130, 135 can be located upstream of the tubulars 110, 120, such as within the adjoining piping or connection flanges on the inlet of the tubulars 110, 120, for example. Suitable instruments 130, 135 include any conventional, fast trending tools that can be monitored using conventional instrumentation or programmable logic control operations. Such suitable instruments 130, 135 should be able to provide data collection at high speed to provide detection of momentary disruptions in flow from a passing sheet in real time. This information can be displayed in a control center for real time monitoring for spikes or become the basis for a suite of alarms.

Likewise, flow rate can be measured and/or determined along or upstream of the tubular (e.g., as the skilled artisan will recognize, flow rate can be derived from the above-described pressure drop measurement using the area of the cross-sectional profile of the tubular or other conduit along which pressure drop is measured). Similarly, drops in the measured and/or determined flow rate value would also be utilized to indicate sheeting, as are decreases in the measured pressure drop value.

It is furthermore contemplated that measuring flow or pressure differential in or upstream of the outer tubular can have a similar indicative value to measuring flow or pressure differential in or upstream of the inner tubular. Therefore, some embodiments can include measuring flow or differential pressure in either or both of the inner tubular and the outer tubular; and in particular, certain of these embodiments include measuring flow or differential pressure in both the inner and outer tubular.

As alluded to already, decreases in measured pressure drop and/or flow rate at a tubular such as those described herein can be excellent indicators of sheeting in the reactor. During polymerization, small clusters or sheets of material (e.g., forming polymer) contacting the outlet or the exit end of a tubular (e.g., the inner tubular 120, outer tubular 110, or both of the device 100) can cause intermittent changes in flowrates and/or pressure drop (also known as differential pressure, delta P or simply DP) through the tubular. Short bursts of flow decrease and/or pressure drop through the tubular can indicate that sheeting is occurring within the reactor 200. By “short bursts” it is meant that flow rates or pressure drop or both through the tubular (e.g., tubular 110 and/or 120 of the device 100 as exemplified in FIG. 1) changes (i.e., decreases) by at least about 30%, about 40%, about 50%, about 65%, about 75%, or about 90% or more within a time frame of about 1 hour or less, 30 minutes or less, 15 minutes or less, or 1 minute or less. The time frame can also range from a low of about 1, 30 or 60 seconds to a high of about 3, 5, or 30 minutes. Operations personnel and/or programs can furthermore define thresholds for such short bursts or predetermined amounts for acceptable variations, such that when the thresholds and/or predetermined amounts are exceeded (e.g., greater than 50% decrease in DP and/or flow rate over a time period ranging from a low of 1 second to a high of 30 minutes, e.g., 5 seconds, or 30 seconds, or the like), then it can be inferred that incipient sheeting has been detected, and one or more steps to mitigate the extent of sheeting and prevent reactor shutdown can be initiated. The decreases are with respect to the measured value of operation before the decrease began; for instance, this could be a steady state operating condition, or it could be an expected operating value (e.g., following a known ramp-up curve during reactor start-up, re-start, or the like, one could measure a continually increasing or decreasing pressure differential consistent with the particular start-up operation being employed, and then detect a sudden decrease (or, where a gradual decrease is expected, detect a sudden, greater-than-expected decrease), indicating potential onset of sheeting).

Sheeting mitigation (that is, remedial measures) can include any suitable action anticipated to reduce or prevent sheeting. For instance, the reactor temperature can be reduced. The monomer feed rate and/or ICA feed rate (e.g., other hydrocarbons, and in particular alkanes such as one or more of propane, butane, pentane; and including n- and iso-variants of the foregoing) can be reduced. The concentration/partial pressure of the hydrocarbons can be reduced, for example, by venting a portion of the reactor overhead and/or recovery unit to the flare. The monomer partial pressure (M-PP) can be adjusted (increase M-PP if productivity is too low, decrease M-PP if too high). Catalyst flow rate/production rate can be reduced. The reactor can be transitioned to a different grade that requires a different operating condition that happens to be commensurate with any of the foregoing corrective measures or that incorporates any of the foregoing corrective measures (that is, the target melt index and/or density of the polymer being produced in the reactor can be changed). The height of the fluidized bed (containing, as noted previously, a plurality of catalyst particles and growing polymer particles) can be increased by, for example, increasing monomer feed rate and/or catalyst feed rate, as well as changing the polymer withdrawal rate from the reactor to the product discharge system. Water or other static inhibitors can be added to the reactor. In any of the foregoing remedial measures, the terms “reduced” or “increased” refer to one or more incremental adjustments that can range from 1% to 20%; 3% to 15%; or 5% to 10% of the rate or value of the parameter that is being adjusted (relative to the value of such parameter prior to the detection of incipient sheeting as indicated by the measured DP reduction and/or flow reduction). Such adjustments can also range from a low of about 1%, 3%, or 5% to a high of about 10%, 30%, 50%, 80% or 99%.

In one particular embodiment, the reactor temperature can be reduced to mitigate the stickiness of the polymer (considering that higher temperature leads to higher stickiness, and therefore higher likelihood of sheeting). Reducing the reactor temperature increases the temperature difference between the polymer melting temperature and the reactor temperature. It is this temperature difference that affects the stickiness of the polymer. Decreasing melt index and/or increasing density also increases the melting point of the polymer, which increases this temperature difference. Decreasing the partial pressure of hydrocarbons, especially the heavy ones, reduces the melt point depression, and therefore increases the melting point (therefore once again increasing difference between reactor temperature and melting temperature). These are a few examples of manipulating the temperature difference between the reactor temperature and melting temperature of the polymer. Additional details of these techniques are explained in U.S. Pat. No. 7,774,178, which is incorporated by reference herein.

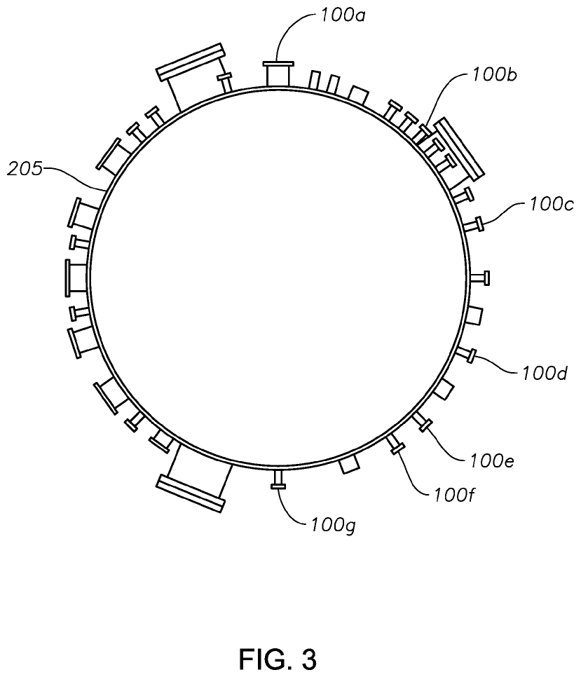

Referring now to FIGS. 2 and 3, FIG. 2 is an elevation profile of a gas phase polymerization reactor 200, and FIG. 3 shows an illustrative top-down partial cross-section view of the reactor 200 through lines 3-3 of FIG. 2, any number of devices 100 can be located about the reactor 200. For example, the reactor 200 can have one two, three, four, five, six, seven, eight or more devices 100 (seven (7) devices are shown 100a-100g in FIG. 3). The device 100 can be used as an injection nozzle for any one or more reaction gases, catalysts, recycle gas, condensing agents, carrier or purge fluids (e.g., carrier or purge gases) and any other fluid (and in particular any gas) that is to be injected in the polymerization reactor 200. For example, a device 100 can be used to provide catalyst particles in carrier fluid, such as in a carrier gas like nitrogen, and/or induced condensing agent (ICA), or the like. Similarly, a device 100 can be used to provide one or more of monomer feed gas, ICA, and purge gas (e.g., nitrogen) to the reactor 200 interior. In certain embodiments, the polymerization reactor 200 can be outfitted with at least two devices 100 for injecting one or more fluids into the reactor 200. Further, it is reiterated that a device 100 is only one embodiment of a tubular that could extend into the reactor; for instance, the devices 100a-g illustrated in FIGS. 2 and 3 can be replaced with a single tubular, or with another arrangement of an inner and outer tubular extending into the interior of the reactor 200 substantially perpendicular to the side wall 205 of the reactor 200 (substantially parallel to the distribution plate 210).

When more than one device 100 is used, the devices 100 can be equally spaced along the wall of the reactor 200 at the elevation at which the devices 100 are disposed along the reactor wall (that is, when the reactor wall 205 is viewed as a circle that is a top-down cross-section of the reactor, the devices 100 can be spaced equally along that circle's circumference). For example, as shown in FIG. 3, the devices 100 can be oriented substantially horizontally within the reactor, and therefore the first and second tubular of the device 100 are also oriented substantially horizontally. Alternatively, the devices 200 do not have to be equally spaced. For example, the two or more devices 100 can be located on one side of the reactor or the same half of the reactor wall at the cross-section at the elevation at which the devices are disposed, as shown in FIG. 3. The two or more devices 100 can be vertically spaced from one another, meaning one or more devices 100 can be located at a first elevation and one or more other devices can be located at a second higher or lower elevation than the first, along the reactor wall 205.

In use with a dry catalyst system, for example, a dry catalyst can be conveyed or carried through the injection tubular 120 from a catalyst feeder into the reactor 200 using a carrier fluid such as a carrier gas (e.g., nitrogen), while monomer or other hydrocarbon gas flows through the surrounding support tubular 110. Preferably, in accordance with previous description, the injection tubular 120 can extend beyond the end of the surrounding support tubular 110, (e.g., by about 1/16″ to 3″, such as about 3/16″), to ensure catalyst flowing through the injection tubular 120 is swept away from the device 100 by the gas flowing through the surrounding support tubular 120. Advantageously, this can also enable better detection of sheeting through any impacts to the inner tubular extending farther into the reactor 200 interior. The flow rates and/or pressure drop of the carrier fluid (e.g., nitrogen) in the inner tubular 120 or other fluid (e.g., hydrocarbon such as monomer and/or ICA and/or purge gas) flowing through the outer tubular 110 can be measured and monitored, e.g., using the respective instrumentation 130, 135 to detect sheet formation within the reactor in real time.

In use with a slurry catalyst system, one or more first set of devices 100 can be used to detect sheeting within the reactor and one or more second set of devices 100 can be used to inject a slurry catalyst system into the reactor. The first and second sets of devices 100 can be the same or different. For example, the first set can simply include the support tubular 110 without the inner, smaller tubular 120 to flow a single type of fluid through the device 100. The second set can include both the support tubular 110 and in the inner injection tubular 120. The second set can optionally include the instrumentation 130, 135 to also detect and/or measure fluctuations in flow rates and/or pressure drops. Similarly, however, the first set (comprising a single tubular) could also be equipped with instrumentation or other means to measure fluctuations in flow rates and/or pressure drops.

A typical slurry catalyst system includes a solvent or suspension fluid used as carrier fluid; for instance, mineral oil, hexane, and/or other hydrocarbon(s), such as one or more ICAs (e.g., iso- or n-propane, butane, pentane, etc.), which advantageously can act as suspension fluid of the catalyst and then act as a coolant in the reactor. Thus, the composition flowing through a tubular in such a slurry catalyst system can include the carrier fluid, at least one catalyst compound, a support and an optional activator. The catalyst system can further include one or more optional light alkyls, such as triisobutyl aluminum, an alumoxane, modified methylalumoxane and/or trimethyl aluminum. Where an inner and outer tubulars are used (e.g., per device 100), such combination is typically injected through the inner tubular 120 of the device 100 into the reactor 200, and a purge fluid is injected into the reactor 200 through the surrounding support tubular 110. The purge fluid (typically fresh monomer, ethylene, hexane, isopentane, recycle gas, and the like) can flow through the support tubular 110 to aid in dispersion of the slurry catalyst composition injected through the inner tubular 120, allowing the production of resin granular particles of good morphology with decreased agglomeration and an APS (average particle size) in the range of about 0.005 to 0.10 inches (0.01 cm to 0.3 cm). The purge fluid helps minimize fouling at the end of the catalyst injection tubular 120 and support tubular 110.

The purge fluid flowing through the support tubular 110 (or other tubular in accordance with the descriptions herein) can be or can include any one or more of hydrogen; olefins or diolefins, including but not limited to C₂ to C₄₀ alpha olefins and C₂ to C₄₀ diolefins, ethylene, propylene, butene, hexene, octene, norbornene, pentene, hexadiene, pentadiene, isobutylene, octadiene, cyclopentadiene, comonomer being used in the polymerization reaction, hydrogen; alkanes, such C₁ to C₄₀ alkanes, including but not limited to isopentane, hexane, ethane, propane, butane, and the like; mineral oil, cycle gas with or without condensed liquids; or any combination thereof. Preferably the support tubular flow is fresh ethylene or propylene that may be heated. In addition, an ICA, such as an alkane, such as for instance isopentane or hexane, can be included in the flow at the level ranging from about 0.001 wt %. to about 50% of the flow. The alkane can be dispersed in the flow and can exist as dispersed liquid droplets or can be vaporized at the exit of the support tubular. The presence of liquid may reduce fouling at the exit.

The flow rate of fluid through the support tubular 110 can range from about 5 to 10,000 pph and is somewhat dependent upon the reactor size and/or diameter of the support tubular 110. The linear velocity of the fluid in the support tubular 110 can range from about 10 to 500 ft/sec (11 to 549 km/hr), preferably about 20 to 300 ft/sec (22 to 329 km/hr) and more preferably about 30 to 200 ft/sec (33 to 219 km/hr).

In certain embodiments, the exit of the support tubular 110 can be tapered to form a jet or dispersion of gas to aid in the distribution of the catalyst composition. In one embodiment, the internal diameter of the support tubular 110 is reduced gradually by about 3 to 80% at the end, preferably about 5 to 50% in a taper to create a nozzle to accelerate to and or disperse the fluid flow. The insertion of the injection tubular 120 is not impacted by the internal taper of the support tubular 110.

As mentioned above, the devices 100 can be used alone or in conjunction with one or more slurry catalyst injection nozzles and/or dry catalyst injection nozzles to detect sheeting within the reactor. The instruments 130, 135 can detect, in real time, intermittent changes in flowrates and/or pressure drop (also known as delta P or simply DP) through either the outer tubular 110 or the inner tubular 120 due to small clusters or sheets of polymer contacting the tip of the device 100. Short bursts of flow fluctuations and/or pressure changes through either the outer tubular 110 or the inner tubular 120 indicate that some sort of blockage is occurring at the end of the device 100, indicating some sort of undesirable solid formation or sheeting is occurring within the reactor 200. Operations can then use this information to take steps to mitigate the extent of the undesirable solids formation and prevent reactor shutdown. Furthermore, by flowing monomer gas through the device 100, instead of nitrogen, venting issues caused by the buildup of inert gases can be avoided or at least substantially reduced. The devices 100 can be used in new installs or existing reactors can be retrofitted to include the devices 100. Similarly, existing catalyst injection nozzles having separate flow channels can be modified to include the instrumentation 130, 135 and operated with a monomer flow to detect intermittent changes in flowrates and/or pressure drop, in real time.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for detecting incipient sheeting in a polyolefin gas phase reactor, comprising:
flowing one or more fluids through a first tubular protruding through a reactor wall in a substantially horizontal orientation at a first elevation above a distribution plate within the reactor, wherein the first tubular has an inner diameter of less than or equal to 0.5 inches;
measuring a pressure differential, a flow rate, or both of the fluid flowing through the first tubular;
detecting a decrease in the measured pressure differential, flow rate, or both, of the fluid; and
based at least in part upon the detected decrease in the measured pressure differential, flow rate, or both, taking one or more remedial measures to control or reverse sheeting in the reactor.

2. The method of claim 1, wherein the first tubular is disposed within a second tubular having inner diameter greater than an outer diameter of the first tubular, and further wherein the first and second tubular are concentric, such that an annulus is defined between the first and second tubulars.

3. The method of claim 2, wherein the second tubular is rigid.

4. The method of claim 2, wherein the first tubular extends into the reactor at least 0.1875 inches beyond the second tubular.

5. The method of claim 2, wherein a pressure differential, flow rate, or both along the second tubular is measured, and further wherein a decrease in the value of pressure differential, flow rate, or both along the second tubular is detected, and one or more remedial measures to control or reverse sheeting in the reactor are taken based at least in part upon the detected decrease in the value of the pressure drop, flow rate, or both along the second tubular,

6. The method of claim 1, wherein the first tubular is flexible.

7. The method of claim 1, wherein the first tubular extends into the reactor a distance within the range from 1/10 to ⅓ of the diameter of the reactor.

8. The method of claim 1, wherein the first elevation is between 0.2 feet and 20 feet above the distribution plate within the reactor.

9. The method of claim 1, wherein the detected decrease in the measured pressure differential, flow rate, or both exceeds a predefined threshold.

10. The method of claim 9, wherein the predefined threshold is a decrease of at least 30% over a time period of 1 minute or less as compared to the measured pressure differential, flow rate, or both immediately prior to the measured decrease.

11. The method of claim 1, wherein the one or more remedial measures comprise one or more of: reducing feed rate of one or more monomers to the reactor; reducing reactor temperature; reducing feed rate of one or more condensing agents to the reactor; venting a portion of a reactor overhead; reducing feed rate of catalyst to the reactor; changing the target melt index and/or density of a polymer being produced in the reactor, and changing the height of a fluidized bed within the reactor

12. The method of claim 1, wherein the inner diameter of the first tubular is 0.25 inches or less.

13. The method of claim 1, wherein the one or more fluids flowing through the first tubular comprise one or more of: a carrier fluid with solid catalyst particles, a monomer gas, an induced condensing agent, and a purge gas.

14. A method for olefin polymerization within a gas phase reactor, comprising:
injecting a catalyst mixture into the gas phase reactor through one or more catalyst injectors that each protrude substantially horizontally through a wall of the reactor at a first elevation within the reactor above a distributor plate within the reactor, wherein each catalyst injector comprises a first tubular disposed within a second tubular having inner diameter greater than the first tubular's outer diameter, forming an annulus therebetween, wherein the catalyst mixture flows through the first tubular and an additional fluid flows through the second tubular, and further wherein the catalyst mixture comprises a plurality of solid catalyst particles and a carrier fluid;
introducing one or more monomer gases into the reactor;
polymerizing the one or more monomer gases in the presence of the catalyst particles within the reactor to form solid polymer particles;
measuring a pressure differential and/or flow rate along the first tubular and/or along the second tubular; and
based at least in part upon a detected decrease in the measured pressure differential and/or flow rate, taking one or more remedial measures to control or reverse sheeting in the reactor,

15. The method of claim 14, wherein the catalyst mixture comprises the plurality of solid catalyst particles entrained within an inert carrier gas or slurried within a solvent.

16. The method of claim 14, wherein the one or more monomer gases are injected into the reactor through one or more monomer injectors protruding substantially horizontally through the wall of the reactor at a second elevation above the distribution plate within the reactor, and further wherein each monomer injector comprises a first monomer injector tubular disposed within a second monomer injector tubular having inner diameter greater than the first monomer injector's outer diameter, forming an annulus therebetween, wherein the one or more monomer gases flow through both the first and second monomer injector tubulars.

17. The method of claim 16, wherein the second elevation of the one or more monomer injectors is located below the first elevation of the one or more catalyst injectors.

18. The method of claim 16, wherein the at least one monomer injector comprises four monomer injectors equally spaced along the reactor wall at the second elevation of the reactor.

19. The method of claim 14, wherein the one or more catalyst injectors comprise four catalyst injectors equally spaced along the reactor wall at the first elevation of the reactor.

20. The method of claim 14, wherein the remedial measures comprise one or more of the following:
reducing the one or more monomer feeds through the first tubular, the second tubular, or both tubulars;
venting the reactor overhead to flare; and
increasing polymer bed level.

21. A method for retrofitting a gas phase polymerization reactor using slurry injection, the method comprising:
adding one or more devices for injecting one or more fluids into the reactor, each device comprising at least one flow path therethrough and one or more instruments for measuring bursts of pressure change along the flow path, wherein the one or more devices are located below catalyst injection nozzles for slurry injection and above a distribution plate within the reactor;
flowing a fluid through each of the one or more added devices;
detecting intermittent pressure drops through each device in order to detect sheet formation within the reactor.

22. The method of claim 21, wherein the flow path through the device has a first end that is flush with the interior face of the reactor wall.

23. The method of claim 21, wherein the flow path through the device has a first end that extends beyond the interior face of the reactor wall into a fluidized bed zone within the reactor.

24. The method of claim 20, further comprising any one or more of the following remedial adjustments if the measured pressure differential exceeds a predetermined amount:
reducing the one or more monomer feed rates through the first tubular, the second tubular, or both tubulars;
venting the reactor overhead to flare; and
increasing polymer bed level.
